(19) United States
(12) Patent Application Publication
(10) Pub. No.: US 2009/0027776 A1
(43) Pub. Date: Jan. 29, 2009

(54) METHOD FOR COATING AN OPTICAL COMPONENT FOR A LASER ARRANGEMENT AND RELATED OPTICAL COMPONENT

(75) Inventors: Michael Schall, Essingen (DE); Bernhard Weigl, Steinheim (DE); Eral Erzin, Koenigsbronn (DE); Jeffrey Erxmeyer, Oberkochen (DE)

Correspondence Address: FISH & RICHARDSON PC, P.O. BOX 1022, MINNEAPOLIS, MN, 55440-1022, US

(73) Assignee: CARL ZEISS LASER OPTICS GMBH, Oberkochen (DE)

(21) Appl. No.: 12/166,657

(22) Filed: Jul. 2, 2008

(30) Foreign Application Priority Data
Jul. 6, 2007 (DE) 10 2007 032 371.0

(51) Int. Cl. G02B 5/18; B05D 5/06

(52) U.S. Cl. 359/571; 427/162; 427/585; 428/181; 428/213

(57) ABSTRACT

A method for coating an optical component comprises providing the optical component. The optical component has a surface formed with parallel, periodically structured surface sections each having a first flank and a second flank. The first flank and the second flank of each surface section are furthermore inclined with respect to one another, and the first flank is formed such that it is smaller than the second flank. The method furthermore comprises at least partly applying a coating to at least the first flank of each surface section. The surface coating has a metal layer and a dielectric multilayer and the metal layer is applied before the dielectric multilayer. The second flank is not coated or is coated with a layer thickness that is formed such that it is smaller than a layer thickness of the surface coating of the first flank.

### CROSS REFERENCE TO RELATED APPLICATION

The application claims priority under 35 U.S.C. § 119 to German patent application No. 10 2007 032 371.0 filed on Jul. 6, 2007, which is hereby incorporated by reference in its entirety.

### FIELD

The disclosure relates to methods for coating an optical component, such as an echelle grating, as well as related components and arrangements. The optical components can be for selecting a defined wavelength for a laser arrangement. The laser arrangements can be for generating a light beam having a defined wavelength that includes such an optical component in reflection arrangement.

### BACKGROUND

An echelle grating can be used e.g. in a reflection arrangement in a laser arrangement in order to select a defined wavelength of a light beam. In this case, a light beam of a wavelength band is incident on the surface of the grating, such that beams having a defined wavelength are reflected in a specific direction at the surface on account of diffraction. The use of such a grating are generally dependent on its surface properties, and it is often desirable that the surface of the grating has a high reflectivity, so that a loss of intensity between the light beam incident on the grating and the light beam reflected by the grating is relatively low. Typically, because energy absorption by the surface can disadvantageously impair the surface, it is also desirable for absorption of the surface of the grating to be relatively small, so that relatively little energy is absorbed by the surface.

### SUMMARY

In some embodiments, the disclosure provides methods by which a surface of an optical component can be coated so that the surface has relatively high diffraction efficiency and relatively low absorption.

In certain embodiments, the disclosure provides an optical component with a coating so that the surface has relatively high diffraction efficiency and relatively low absorption.

In some embodiments, the disclosure provides a laser arrangement that includes at least one optical component with a coating so that the surface has relatively high diffraction efficiency and relatively low absorption.

In certain embodiments, the disclosure provides an optical component with a coating that results in little or no a rounding of the profile edges between the blaze and antiblaze flanks. This can result in little or no efficiency inhomogeneity over the surface extent of the optical element.

In some embodiments, the disclosure provides an optical component with a surface coating that has little or no layer thickness inhomogeneity over the surface extent, such as little or no layer thickness inhomogeneity over the surface extent of the dielectric layer(s). This can result in little or no diffraction efficiency inhomogeneity. This can result in little or no loss of intensity between incident and reflected light at the ends of the surface extent of the optical element.

In some embodiments, the disclosure provides a method for coating an optical component for a laser arrangement is provided. The method includes: (a) providing the optical component, wherein a surface of the optical component is formed with parallel, periodically structured surface sections each having a first flank and a second flank, wherein the first flank and the second flank of each surface section are inclined with respect to one another, and wherein the first flank is smaller than the second flank; and (b) at least partly applying a surface coating to at least the first flank of each surface section, wherein the surface coating has a metal layer and a dielectric multilayer, wherein the metal layer is applied before the dielectric multilayer, wherein the second flank remains uncoated or is only coated with a layer thickness that is smaller than a layer thickness of the surface coating of the first flank.

Optionally, the second flank is coated with a layer thickness that is smaller than a layer thickness of the surface coating of the first flank multiplied by the cosine of an application angle η relative to a surface normal to the second flank for the surface coating of the second flank.

In certain embodiments, the disclosure provides an optical component for selecting a defined wavelength for a laser arrangement is provided, including a surface having parallel, periodically structured surface sections, wherein each surface section has a first flank and a second flank which are inclined relative to one another, wherein the first flank is smaller than the second flank, and wherein furthermore, at least the first flank of each surface section at least partly has a surface coating composed of a metal layer and a subsequently applied dielectric multilayer, wherein the second flank is uncoated or coated with a layer thickness smaller than a layer thickness of the surface coating of the first flank.

Optionally, the second flank is coated with a layer thickness that is smaller than a layer thickness of the surface coating of the first flank multiplied by the cosine of an application angle η relative to a surface normal to the second flank for the surface coating of the second flank.

In some embodiments, the disclosure provides a laser arrangement for generating a light beam having a defined wavelength including an optical component according to the disclosure in reflection arrangement.

In some embodiments, the optical component and the laser arrangement enable a surface coating of the optical component which has a metal layer and a dielectric multilayer each having different layer thicknesses on the first flanks and the second flanks of each surface section. The layer thickness of the surface coating of the second flank is formed such that it is smaller, optionally smaller by at least half, than the layer thickness of the first flank. It is likewise possible for the second flank not to be coated. Since, the reflection properties of the surface of an optical component and, consequently, also the diffraction efficiency of the surface are influenced by the surface coating of the second flanks, a reduction of the layer thickness of the surface coating of the second flanks advantageously leads to a reduction of absorption effects of incident light in the second flanks, such that optical damage to the surface of the optical component and associated deterioration of the optical properties of the surface do not occur there. Therefore, it is particularly advantageous if the second flanks are not coated since a particularly optimum surface coating of the optical component is achieved whose reflectivity is particularly high and which simultaneously has lower absorption effects in comparison with a surface coating on the first and second flanks.

Furthermore, a smaller layer thickness of the surface coating of the second flanks or an absent surface coating of the second flanks brings about an increase in the reflectivity and hence the diffraction efficiency of the optical component, such that losses of intensity between incident and reflected light are advantageously reduced and, consequently, a laser source of a laser arrangement can be formed such that it is comparatively weaker.

Furthermore, it is advantageous that as a result of a smaller layer thickness of the surface coating of the second flanks or as a result of an absent surface coating of the second flanks, the rounding of the profile edges between the first and second flanks that is known from the prior art is reduced since, during the coating process, the coating material principally deposits on the first flanks and defined edges are maintained between the first flanks and the second flanks. This can prevent an impairment of the reflection properties of the surface of the optical component.

In some embodiments, the surface coating is applied to the surface sections by electron beam evaporation.

This measure advantageously provides a suitable possibility for applying a homogeneous surface coating for the optical component which can be carried out by a conventional vapour-deposition installation.

In certain embodiments, an application angle ε relative to a surface normal to the first flank for the surface coating of the first flank is below 10°, such as below 5°, and an application angle η relative to a surface normal to the second flank for the surface coating of the second flank is above 85°, such as above 90°.

In a particularly simple case, the vapour-deposition beam directions for the first and second flanks run in identical fashion, e.g. only one material source is used for the coating material of both flanks. Setting the application angles ε, η to the values mentioned above has the effect that the applied surface coating has a smaller layer thickness on the second flanks of each surface section than on the first flanks. If an application angle η for the surface coating of the second flanks is above 90°, then the second flank of the surface section is not coated. As a result of this, the surface coating of the optical component according to the disclosure is advantageously produced only on the first flank (blaze flank) which has a particularly high reflectivity and, consequently, a high diffraction efficiency.

In some embodiments, a tilt angle δ of the optical component with respect to the horizontal is altered for setting the application angle ε, η for the surface coating. This measure has the advantage that the setting of the application angle ε, η can be carried out particularly flexibly by tilting the optical component in the vapour deposition installation. As a result of this, in particular for setting the application angle ε, η for the surface coating of the first and second flanks, it is not necessary to alter e.g. the arrangement of a material source for the surface coating in the vapour-deposition installation.

In certain embodiments, at most 30% of the first flank is not coated depending on the application angle ε for the surface coating of the first flank.

It has been shown that an optical component whose first flanks have a shading of more than approximately 30% does not have the desired effect with regard to diffraction efficiency and reflectivity. Therefore, during the coating process, the application angles ε are chosen in such a way that at least 70% of the first flanks is coated.

In some embodiments, during coating at least one diaphragm is arranged between the optical component and a material source for the metal layer and for the dielectric multi-layer for the purpose of delimiting vapour-deposition beams.

It has emerged while carrying out the coating method according to the disclosure that the arrangement of at least one diaphragm having a suitable form advantageously brings about an approximately constant diffraction efficiency over the surface extent of the optical component, e.g. by the diaphragm being positioned in the vapour-deposition installation in such a suitable manner that a vapour-deposition beam profile with a sharp edge is produced and an approximately constant layer thickness over the surface extent of the grating was achieved.

In certain embodiments, the surface coating is applied at room temperature.

This measure has the advantage that the coating method according to the disclosure can be carried out in a technically simple manner since, in particular, heating of the coating installation is not required.

In some embodiments, an aluminum layer is applied as the metal layer.

This measure has the advantage that the application of a reflective aluminum layer to the optical component, the surface of which usually also has an aluminum layer and possibly an MgF₂ layer, can be carried out in a particularly simple manner and the additionally applied aluminum layer represents a surface having defined properties for the layers that are still to be further applied. Furthermore, the additional aluminum layer reinforces the already existing aluminum layer of the optical component thereby compensating for possible surface damage to the already existing aluminum layer or the MgF₂ layer and enabling an optimum reflectivity of the surface of the optical component.

In certain embodiments, a plurality of layers composed of a first material and composed of a second material are applied in an alternating sequence as the dielectric multilayer.

This measure has the advantage that the additionally applied layers composed of the two materials additionally increase the reflection of the aluminum layer.

Furthermore, a particularly good surface passivation of the optical component is advantageously achieved by this measure in comparison with a finally applied dielectric layer composed of only one material, which surface passivation not only affords optimum protection against e.g. surface oxidation or moisture but also enables the diffraction efficiency of the optical component to be increased.

In some embodiments, in each case four layers composed of the first and the second material are applied.

This measure advantageously provides a dielectric multilayer having a sufficiently large layer thickness, such that a sufficient surface passivation of the underlying reflective aluminum layers is achieved.

In certain embodiments, a layer thickness of the layers composed of the first material is formed such that it is approximately twice as large as a layer thickness of the layers composed of the second material.

This measure has the advantage that different layer thicknesses of the individual layers of the dielectric multilayer can optimize the surface properties thereof with regard to desired moisture resistance, diffraction efficiency, etc.

In some embodiments, a layer thickness of the first applied layer composed of the first material approximately corresponds to the layer thickness of the layers composed of the second material.

This measure has the advantage that this choice of the layer thicknesses of the first applied layer composed of the first material and the layers composed of the second material enables an adaptation of the optical path length of the layers for a predetermined refractive index of the materials of the layers, whereby the reflection of the surface coating of the multilayer is maximized.

In some embodiments, a layer thickness of the metal layer is formed such that it is approximately twice as large as the layer thickness of the layers composed of the first material.

This measure has the advantage that the surface coating of the optical component has optimum reflection properties since the metal layer is made sufficiently thick. In connection with the configuration of the metal layer as an aluminum layer, this choice of the layer thickness of the metal layer is particularly advantageous since a maximum reflection of the surface coating of the optical component occurs for light beams having a wavelength of 193 nm that are incident on the surface coating of the optical component.

In some embodiments, the first material includes Na₅Al₃F₁₄ and the second material includes Al₂O₃.

This measure has the advantage that the combination of these two materials is particularly suitable for coating the surface of the optical component since the dielectric multi-layer produced from the materials enables an optimum surface passivation of the optical component. In particular, the alternate application of layers composed of Na₅Al₃F₁₄ (chiolite) and Al₂O₃ (aluminum oxide) permits an optimum reflection on account of the layer morphology of the two materials with respect to one another. The use of Na₅Al₃F₁₄ as material for the dielectric multilayer advantageously enables an optimum transition of the interfaces between the Na₅Al₃F₁₄ layers and the Al₂O₃ layers since Na₅Al₃F₁₄ grows very smoothly.

In some embodiments, an Al₂O₃ layer is applied as the last layer of the multilayer.

This measure has the advantage that the application of an aluminum oxide layer enables an optimum passivation of the surface with respect to moisture.

The optical component according to the disclosure and the laser arrangement according to the disclosure have the properties of the surface coating of the optical component which are brought about by the method according to the disclosure and the advantageous effect of which has been described above.

According to still another aspect of the disclosure, a method for coating an optical component for a laser arrangement is provided, including the steps of: (a) providing the optical component, wherein a surface of the optical component is formed with parallel, periodically structured surface sections each having a first flank and a second flank, wherein the first flank and the second flank of each surface section are inclined with respect to one another, and wherein the first flank is smaller than the second flank; (b) at least partly applying a surface coating to at least the first flank of each surface section, wherein the surface coating has a metal layer and a dielectric multilayer, wherein the metal layer is applied before the dielectric multilayer, wherein the step of at least partly applying the surface coating includes setting an application angle ε relative to a first surface normal to the first flank for the surface coating of the first flank below 10°.

According to still another embodiment, an optical component for selecting a defined wavelength for a laser arrangement is provided, including a surface having parallel, periodically structured surface sections, wherein each surface section has a first flank and a second flank which are inclined relative to one another, wherein the first flank is smaller than the second flank, and wherein furthermore, at least the first flank of each surface section at least partly has a surface coating composed of a metal layer and a subsequently applied dielectric multilayer, wherein a ratio of a layer thickness of the coating of the second flank and a layer thickness of the coating of the first flank is in a range from 0 to about ⅓.

Further advantages and features will become apparent from the following description and the accompanying drawing.

### BRIEF DESCRIPTION OF THE DRAWINGS

The disclosure is described and explained in more detail below on the basis of some selected exemplary embodiments in connection with the accompanying drawing, in which:

FIG. 1A shows a schematic profile excerpt from an optical component in cross section with a surface coating on first flanks;

FIG. 1B shows a further schematic profile excerpt from the optical component in FIG. 1A in cross section with a surface coating on first and second flanks;

FIG. 2 shows a schematic illustration of a vapour-deposition installation;

FIG. 3 shows a schematic illustration of two vapour-deposition configurations of a surface section of the optical component in FIGS. 1A, 1B;

FIG. 4 shows an illustration of application angles ε, η for the surface coating during a coating process;

FIG. 5 shows an illustration of a shading factor f of the first flanks during the coating process in FIG. 4;

FIG. 6 shows an exemplary embodiment of the surface coating in FIGS. 1A, 1B;

FIG. 7 shows a wavelength-dependent reflectivity of the optical component with the surface coating in FIG. 6;

FIG. 8 shows diffraction efficiencies of the optical component for different layer thicknesses of the surface coating in FIG. 6;

FIG. 9 shows calculated reflectivities of the optical component with and without an interference effect;

FIG. 10 shows a relative layer thickness change of the surface coating in FIG. 6;

FIG. 11 shows diffraction efficiencies of the optical component for a coating process with and without a diaphragm; and

FIG. 12 shows a laser arrangement including the optical component in FIGS. 1A, 1B.

### DETAILED DESCRIPTION

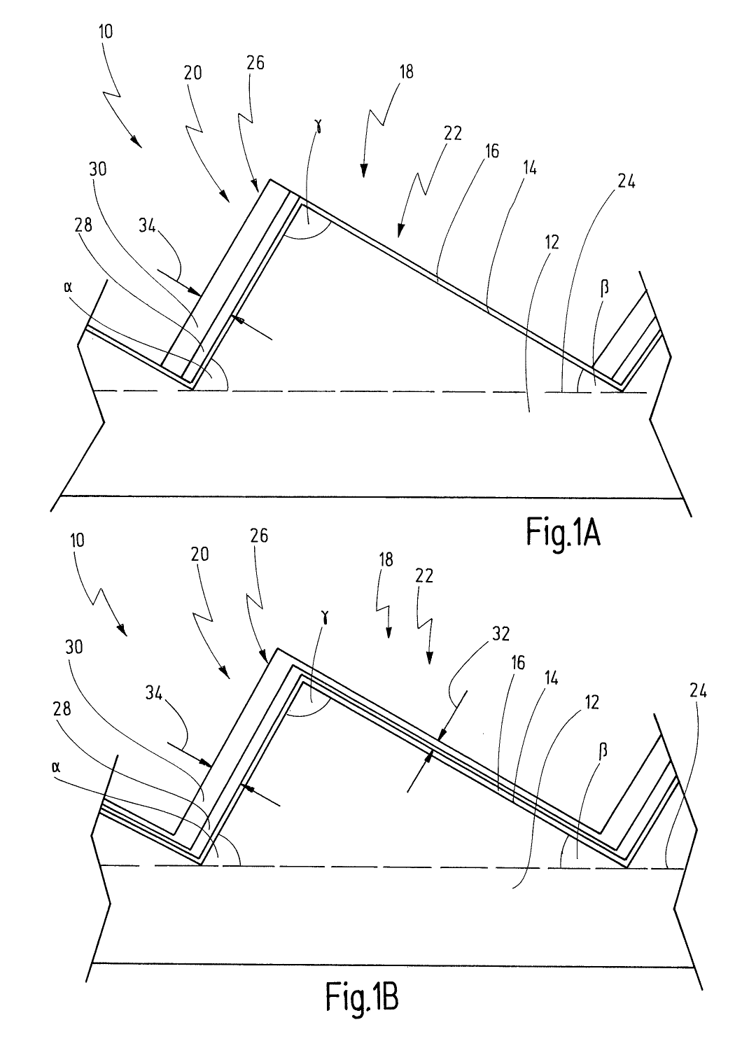

FIGS. 1A, 1B illustrate a schematic profile excerpt from an optical component provided with the general reference symbol 10. Optical component 10 can be an echelle grating for a laser arrangement, which grating can be used to generate a light beam having a defined wavelength. The echelle grating can be accommodated in Littrow arrangement in the laser arrangement in order, by wavelength-selective reflection, to reduce a bandwidth of a light beam incident on the optical component 10.

In order to be able to be used in reflection arrangements, for example, a surface of the optical component 10 desirably has a high reflectivity, that is to say a high diffraction efficiency. Furthermore, an absorption of incident light beams on the surface of the optical component 10 desirably is relatively small to reduce optical damage to the surface of the optical component 10.

The optical component 10 can be provided e.g. by ion beam etching of a groove profile into its surface or in the method of copying an already existing optical component 10.

The optical component has a substrate 12 with a surface 14 to which a metal layer 16 composed of aluminum, for example, is applied. The surface 14 of the optical component 10 has parallel, periodically structured surface sections 18. Each surface section 18 has a first flank 20 and a second flank 22. In the case where the optical component 10 is an echelle grating, the first flank 20 is usually referred to as the blaze flank and the second flank 22 the antiblaze flank. The first flank 20 and the second flank 22 are inclined at a so-called apex angle γ with respect to one another, which angle can be approximately 85° for the echelle grating, for example. A blaze angle α between the first flank 20, that is to say the blaze flank, and a base flank 24 is significantly greater than an antiblaze angle β between the second flank 22, that is to say the antiblaze flank, and the base flank 24, with the result that the first flank 20 is formed such that it is smaller than the second flank 22. The blaze and antiblaze angles α and β are e.g. approximately 80° and 15°, respectively. The surface sections 18 are arranged so densely that a grating width of the surface groove profile of the optical component 10 in the range of a few micrometres can be achieved.

A surface coating 26 formed from a further metal layer 28, such as an aluminum layer, and a dielectric multilayer 30 can be applied to the surface 14 of the optical component 10, that is to say to the metal layer 16, by e.g. electron beam evaporation. The metal layers 16, 28 serve as reflective layers on the surface 14 of the optical component 10, while the dielectric multilayer 30 on the one hand enhances reflection intensification and on the other hand assists in surface passivation of the optical component 10 in order to protect the surface 14 against e.g. moisture or oxidation.

The surface coating 26 is at least partly applied to at least the first flank 20 of each surface section 18. Optionally, the second flank 22 of the surface sections 18 does not include coating 26 (cf. FIG. 1A). However, in some embodiments, the second flank 22 can also have a surface coating 26. The layer thickness 32 of the surface coating 26 on the second flank 22 can be smaller, e.g. smaller by at least half, than a layer thickness 34 of the surface coating 26 of the first flank 20 (cf. FIG. 1B). Optionally, the layer thickness 32 of the surface crating 26 is smaller than one third of the layer thickness 34 of the surface coating 26 of the first flank, for example smaller than one fifth or yet smaller than one tenth thereof. The surface coating 26 on the second flanks 22 can, e.g. take place unintentionally during the coating process of the first flanks 20 or be applied in a targeted manner during the coating process of the surface sections 18 of the optical component 10.

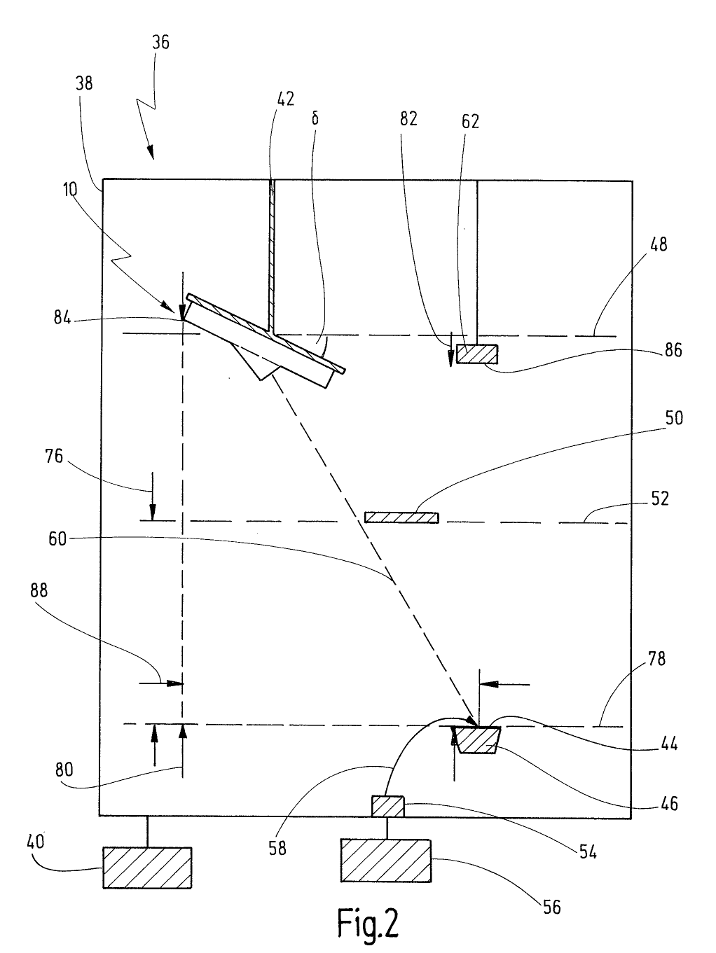

FIG. 2 shows a vapour-deposition installation 36 for at least partly applying the surface coating 26 to at least the first flank 20 of each surface section 18 of the optical component 10. The vapour-deposition installation 36 has a housing in the form of a chamber 38, for example, at which a vacuum pump 40 is arranged in order to evacuate an interior of the chamber 38 to at least 10⁻¹² bar. Furthermore, a mount 42 is arranged in the chamber 38, the optical component 10 being accommodated in the mount. A tilt angle δ with respect to the horizontal, that is to say with respect to a plane 48 parallel to a surface 44 of a material source formed as a crucible 46, can be set by the mount 42. A tilt angle δ=0 should be understood to mean the horizontal arrangement of the optical component 10 in the vapour-deposition installation 36. For orienting the optical component 10 with respect to the crucible 46 it is likewise possible to alter an arrangement of the crucible 46 with respect to the optical component 10 e.g. by rotation, displacement or tilting.

Furthermore, at least one diaphragm 50 for delimiting vapour-deposition beams is arranged between the crucible 46 and the optical component 10. The diaphragm 50 has a suitable form by which the optical component 10 can be at least partly concealed during a coating process. The diaphragm 50 can be tilted from a plane 52 parallel to the plane 48 and can be displaced in the plane 52.

The surface 14 of the optical component 10 is coated by electron beam evaporation. For this purpose, an electron evaporator 54 with an associated power source 56 is arranged in the chamber 38. Electrons 58 emitted by the electron evaporator 54 impinge on the crucible 46 and melt the coating material arranged in the crucible 46 for the vapour deposition of the surface 14 of the optical component 10. Material particles 60 evaporated from the crucible 46 impinge on the surface 14 of the optical component 10 and deposit on the surface, whereby the surface coating 26 of the optical component 10 is applied to the surface of the optical component 10. In order to control the coating process, the vapour-deposition installation 36 has an oscillating quartz crystal 62 arranged approximately perpendicular above the crucible 46. The coating process of the surface 14 of the optical component 10 can take place at room temperature, such that the interior of the chamber 38 does not have to be heated.

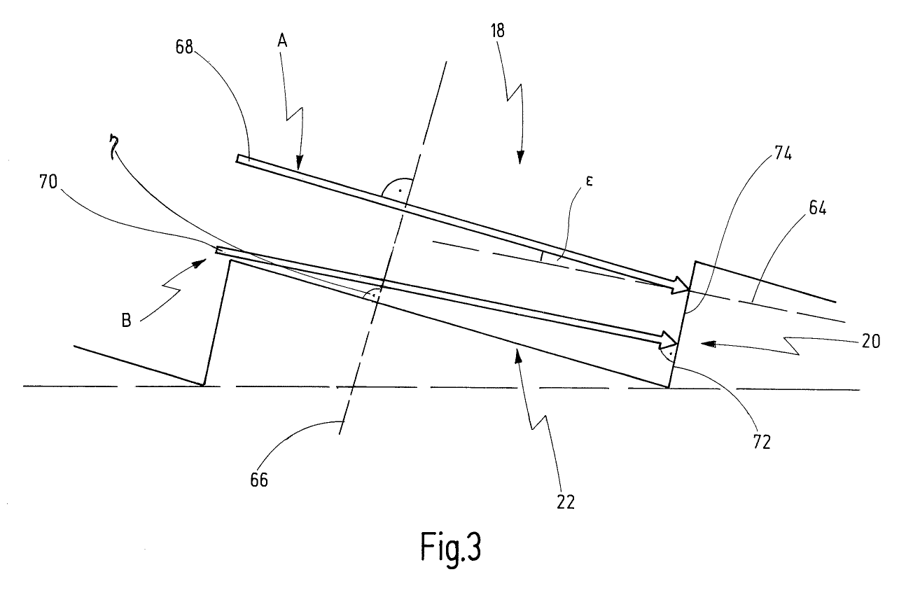

Depending on the tilt angle δ set, application angles ε, η of the surface coating 26 for the first flank 20 and the second flank 22 vary along an extent of the surface 14 of the optical component 10. FIG. 3 shows by way of example two different vapour-deposition configurations A, B for a defined tilt angle δ, which are represented at a surface section 18 for illustration purposes. The application angles ε, η are respectively defined as intermediate angles between a surface normal 64 and 66, respectively, to the first flank 20 and the second flank 22, respectively, and a vapour-deposition beam 68, 70 of the two vapour-deposition configurations A, B, which result from a spatial position x along the surface extent of the optical component 10. In the case of the vapour-deposition configuration A, the vapour-deposition beam 68 runs parallel to the second flank 22, such that the application angles ε, η are approximately 5° and 90°, respectively, in accordance with the above mentioned angles α, β and γ. In the case of the vapour-deposition configuration B, the application angles ε, η are approximately 0° and 95°, respectively, such that a shading of the first flank 20 occurs in a first region 72 between the first flank 20 and the second flank 22. Consequently, only a second region 74 of the first flank 20 is coated in the case of the vapour-deposition configuration B.

The tilt angle δ can be set in such a way that the application angle ε of the surface coating 26 for the first flank 20 is below 10°, such as below 5°, and the application angle η of the surface coating 26 for the second flank 22 is above 85°, such as above 90°.

FIG. 4 shows by way of example for an echelle grating having the length 250 mm, the width 30 mm, and the height 30 mm, the achievable application angles ε, η of the surface coating 26 for the first flank 20 and the second flank 22 along the position x, wherein the tilt angle δ of the optical component 10 was set to 50°. Furthermore, during the coating process, a distance 76 between a plane 78 in which the surface 44 of the crucible 46 is accommodated and the plane 52 in which the diaphragm 50 is arranged is approximately 56 cm (cf. FIG. 2). A vertical distance 80 and 82 between the plane 78 and an end 84 of the optical component 10 that is the furthest away from the crucible 46 and, respectively a surface 86 of the oscillating quartz crystal 62 that faces the crucible 46 is approximately 85 cm and 78 cm, respectively. A horizontal distance 88 from a centre of the surface 44 of the crucible 46 to the end 84 of the optical component 10 is approximately 47 cm.

A position x=0 in FIG. 4 corresponds to the vapour-deposition configuration A in FIG. 3, wherein this should be understood to mean that position on the surface 14 of the optical component 10 which correspondingly lies the closest to the crucible 46 in FIG. 2. The position x=10 corresponds to the vapour-deposition configuration B and denotes that position on the surface 14 of the optical component 10 which is the furthest away from the crucible 46. As position x increases, that is to say as the distance from the crucible 46 increases, the application angles ε, η decrease approximately linearly from approximately 5° to approximately 0° and respectively increase from approximately 90° to approximately 95°. As position x increases, the second flank 22 is generally no longer coated, where no coating of the second flank 22 takes place starting from an application angle η=90°. Furthermore, the first flank 14 is increasingly shaded, such that the uncoated region 72 increases in comparison with an overall extent of the first flank 20.

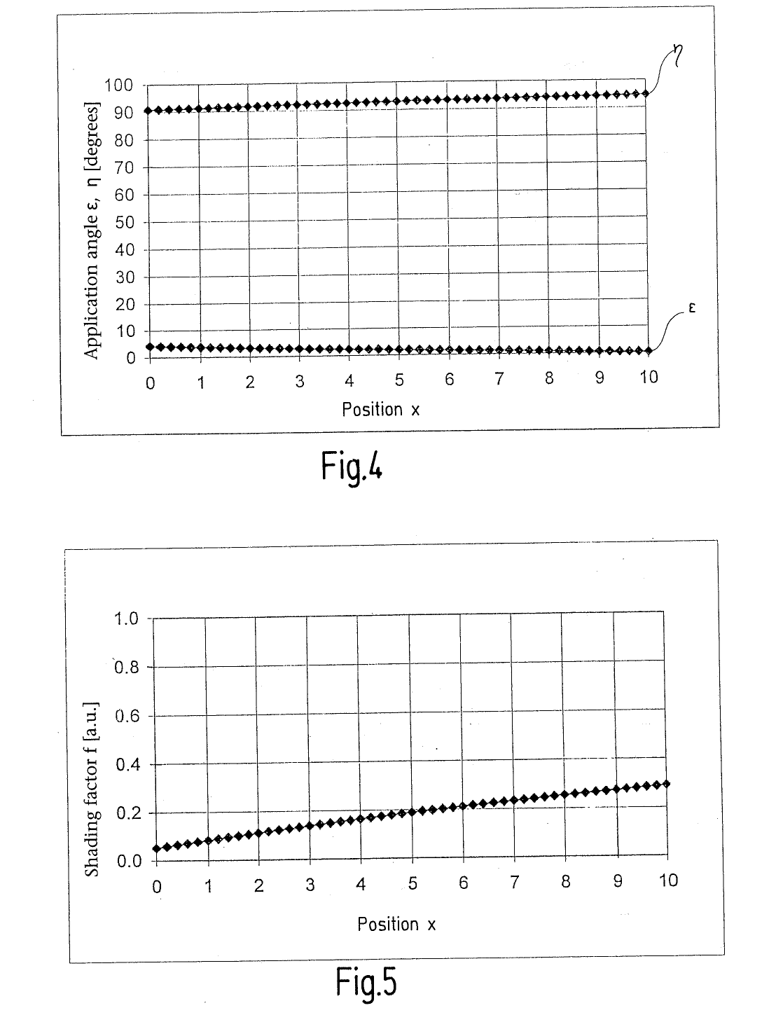

As illustrated in FIG. 5, for this example a relative shading factor f, which is defined as the ratio of the region 72 to the overall extent of the first flank 20, correspondingly increases approximately linearly from 0.05 to 0.3 as position x increases.

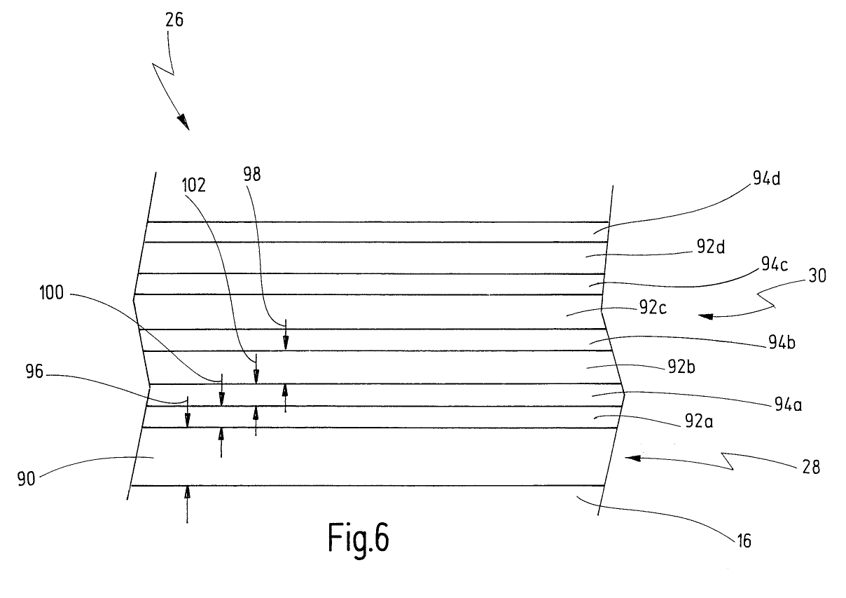

FIG. 6 shows an exemplary embodiment of the surface coating 26 applied to the aluminum layer 16. The first applied metal layer 28 of the surface coating 26 is likewise formed from aluminum. The dielectric multilayer 30 having a plurality of layers composed of a first material and composed of a second material that are applied in an alternating sequence is applied to the aluminum layer 90. Optionally, the dielectric multilayer, as illustrated in FIG. 6, has alternately four layers 92 a-d composed of the first material chiolite (Na₅Al₃F₁₄) and four layers 94 a-d composed of the second material aluminum oxide (Al₂O₃), wherein an aluminum oxide layer is applied as the last layer 94 d. A layer thickness 96 of the aluminum layer 90 is formed such that it is approximately twice as large as a layer thickness 98 of the layers 92 b-d. Furthermore, a layer thickness 100 of the first applied layer 92 a composed of the first material corresponds to a layer thickness 102 of the layers 94 a d, which is formed such that it is approximately half as large as the layer thickness 98 of the layers 92 b d. By way of example, the layer thickness 96 of the aluminum layer 90, the layer thickness 100 of the first applied chiolite layer 92 a, the layer thickness 102 of the aluminum oxide layers 94 a d and the layer thickness 98 of the subsequently applied chiolite layers 92 b d are approximately 70 nm, 26 nm, 23 nm and 41 nm, respectively.

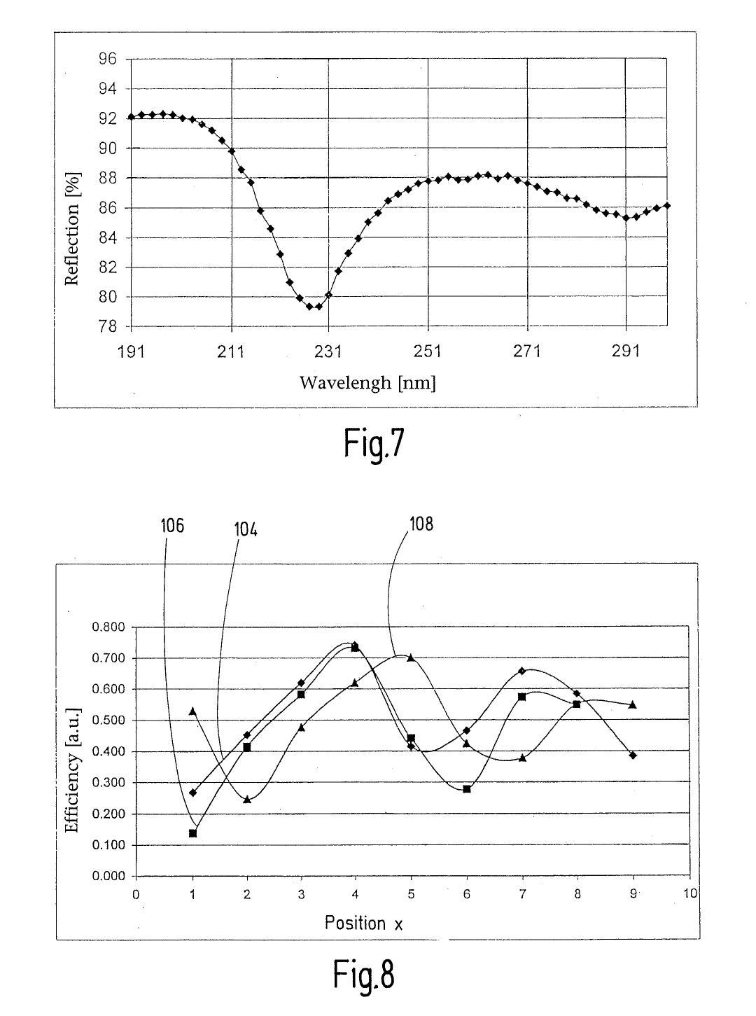

FIG. 7 shows a wavelength-dependent reflection profile of a measurement plate with the surface coating 26 described in FIG. 6. The surface coating 26 was applied by vapour-deposition of the measurement plate in the vapour-deposition installation 36 for a tilt angle δ=50° at the position x=5, wherein the measurement plate was arranged in accordance with the blaze angle α. The measurement was carried out on a spectrometer at 10° and with p polarized light (TM polarization). For a wavelength of approximately 193 nm, which corresponds to an ArF laser, the reflection profile has a maximum and is approximately 92%. As the wavelength increases, the reflection decreases to a minimum value of approximately 79% at approximately 228 nm. At a wavelength of 248 nm, which corresponds to a KrF laser, the reflection increases to approximately 88% and in the further profile remains approximately constant around a value of 86%.

FIG. 8 shows three efficiency profiles 104 108 of three coated optical components 10 as a function of the position x for a tilt angle δ=50°, wherein the surface coatings 26 on which the efficiency profiles 104, 106 are based correspond to the surface coating 26 described in FIG. 6. The efficiency profile 108 is brought about by a surface coating 26 having layer thicknesses 96 102 larger by approximately 7% than described in FIG. 6. The efficiency profiles 104, 106 have at approximately the position x=4 an efficiency maximum of approximately 73%, which corresponds to an efficiency that is higher by approximately 10% than that known from the prior art. The efficiency profile 108 has approximately at the position x=5 a maximum of approximately 70%, such that larger layer thicknesses 96 102 lead to a slight reduction of the efficiency.

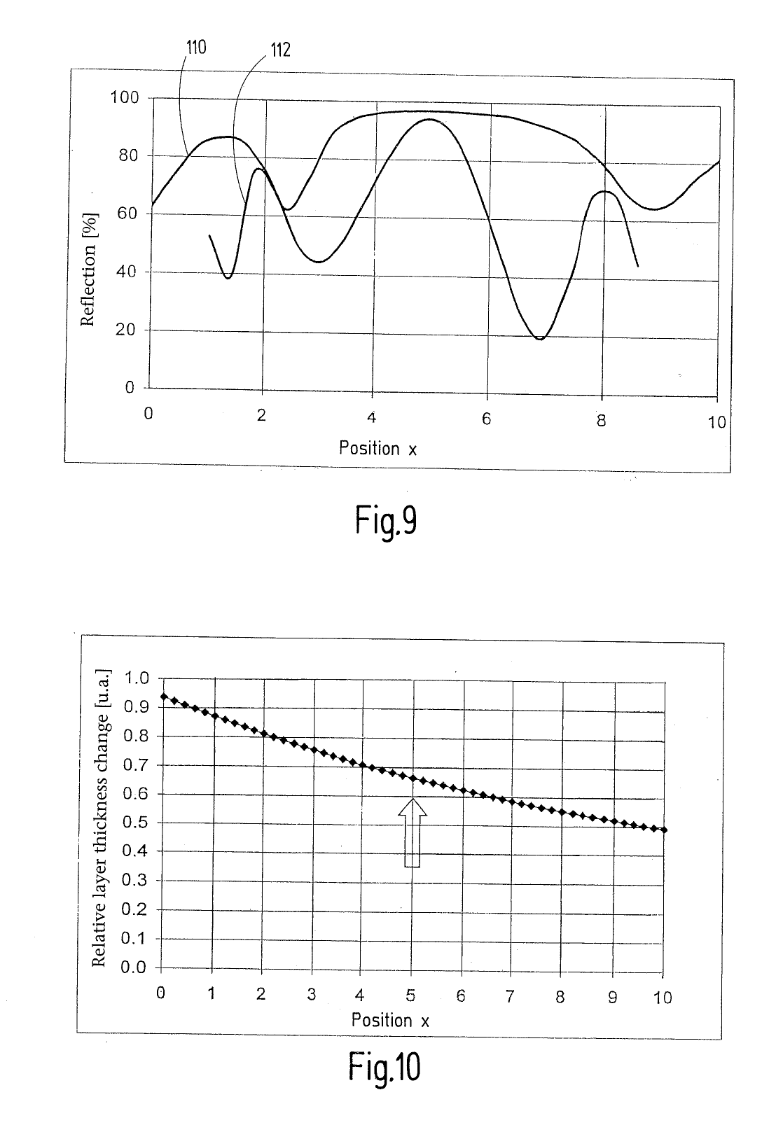

The efficiency profiles 104-108 of the surface coatings 26 can be clarified by reflection profiles 110, 112 illustrated in FIG. 9. The reflection profiles 110, 112, were measured on measurement plates which, during the coating process, were arranged in the vapour-deposition installation 36 in such a way that an optimum reflection profile is obtained at the position x=5, that is to say at a centre of the optical component 10 (cf. FIG. 7).

A deviation of the layer thickness 34 of the surface coating 26 of the first flank 20 with respect to the centre of the optical component 10, as illustrated by way of example as a relative layer thickness change in FIG. 9, leads to a shift in the reflection curve illustrated in FIG. 7 to higher wavelengths and, consequently, to a change in the reflection value at a wavelength of 193 nm. The reflection profile 110 as a function of the position x results computationally on the basis of the relative layer thickness change illustrated in FIG. 9. The reflection profile 110 has an intensity maximum of approximately 95% in the region of the positions x=3 to x=6 and inadequately describes the actual efficiency profiles 104, 106.

A further contribution to be taken into account for the reflection profiles 110, 112 is the shading factor f of the first flank 14 as illustrated in FIG. 5. If the first flank 14 is only partly coated, that is to say that it has the surface coating 26 only in the region 74 (cf. FIG. 3), then a reflection of light beams at the coated region 74 of the first flank 14 and at the uncoated region 72 of the first flank 14 leads to an interference of the reflected light beams in accordance with
Error! Objects cannot be created from editing field codes.,
   where R_{INT} corresponds to the reflection that arises as a result of interference, and R_{A} and R_{B} denote the reflection at the uncoated region 72 and at the coated region 74, respectively, of the first flank 14. A phase difference Δφ occurs, on the one hand, between the uncoated and coated regions 72, 74 and, on the other hand, in the coated region 74 in accordance with the doubly applied layer thicknesses 92, 102. The reflection profile 112 calculated on the basis of this interference effect and the layer thicknesses 96, 102 chosen approximately correspond to the actually observed efficiency profile 108 in FIG. 8.

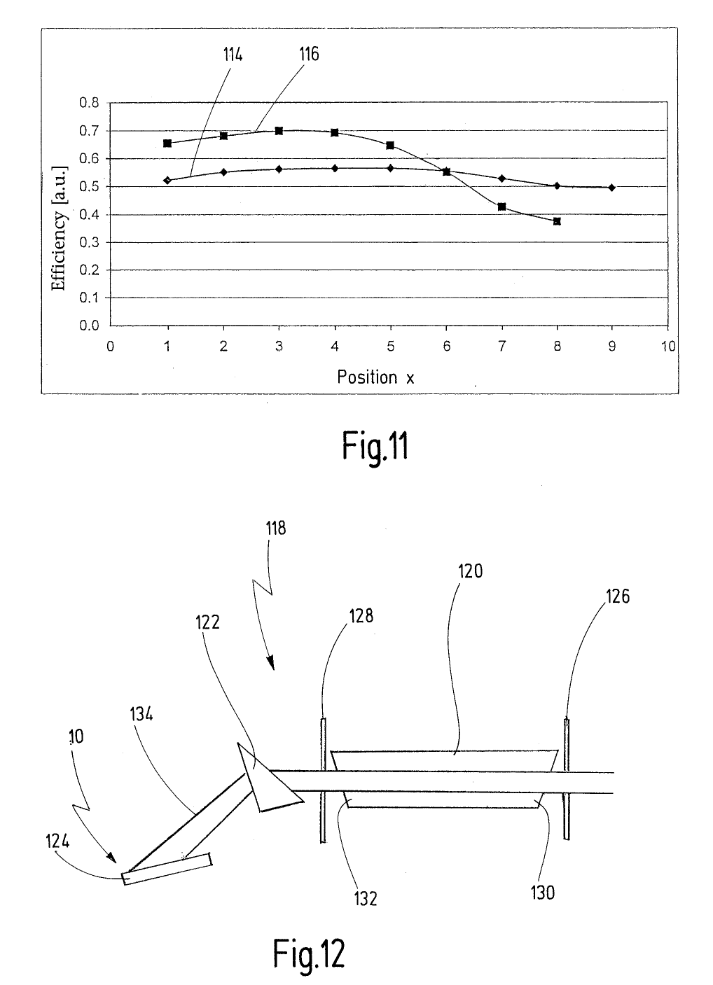

In order to achieve an approximately constant efficiency of the optical component 10 over its entire extent, the at least one diaphragm 50 having the suitable form is inserted between the crucible 46 and the optical component 10 during the coating process. FIG. 11 shows an efficiency profile 114, 116 before and after a coating process using the diaphragm 50. The efficiency profile 116 has efficiency values that are higher by approximately 10% than the efficiency profile 114. Furthermore, the efficiency profile 116 is significantly wider in comparison with the efficiency profiles 104, 106 in FIG. 8, such that an approximately constant efficiency is achieved in the range from approximately x=1 to x=5.

FIG. 12 shows a schematic laser arrangement 118 having a laser resonator 120, a beam expander 122, the optical component 10 in the form of the echelle grating 124 and a respective diaphragm 126, 128 at a respective end region 130, 132 of the laser resonator 120. In the laser resonator 120, light beams 134 of a narrow wavelength band are generated and then emerge from the laser resonator 120 through the end region 132. After collimation by the diaphragm 128 and beam expanding by the beam expander 122, the light beams 134 impinge on the first flanks 20 of the echelle grating 124 arranged in Littrow arrangement, such that they are reflected in a wavelength-selective manner at the grating. Light beams having a defined wavelength, e.g. a wavelength of 193 nm or 248 nm, are thereby generated, which, after once again passing through the beam expander 122, the diaphragm 128 and the laser resonator 120, then emerge from the end region 130 of the laser resonator and are collimated by the diaphragm 126 prior to further use.

It goes without saying that the features mentioned above and the features yet to be explained below can be used not only in the combinations indicated but also in other combinations or by themselves, without departing from the scope of the present disclosure.

Other embodiments are covered by the claims.

What is claimed is:

1. A method, comprising:
providing an optical component, a surface of the optical component being formed with parallel, periodically structured surface sections, each surface section having a first flank and a second flank, the first and second flanks of each surface section being inclined with respect to one another, and the first flank of each surface section being smaller than the second flank of the surface section; and
applying a coating to at least part of the first flank of each surface section, the coating including a metal layer and a dielectric multilayer, the metal layer being applied before the dielectric multilayer, and the second flank being uncoated or coated with a layer thickness that is smaller than a layer thickness of the coating of the first flank.

2. The method of claim 1, wherein the coating is applied to the surface sections by electron beam evaporation.

3. The method of claim 1, further comprising delimiting vapor-deposition beams with at least one diaphragm between the optical component and a material source for the coating.

4. The method of claim 1, wherein the coating is applied at room temperature.

5. The method of claim 1, wherein the metal layer comprises aluminum.

6. The method of claim 1, wherein the dielectric multilayer comprises a plurality of first layers including a first material and a plurality of second layers including second material, the first and second layers being in an alternating sequence.

7. The method of claim 6, wherein the dielectric multilayer comprises four of the first layers and four of the second layers.

8. The method of claim 6, wherein a thickness of each of the first layers is approximately twice as much as a thickness of each of the second layers.

9. The method of claim 6, wherein a first applied layer of the plurality of first layers has a thickness that is approximately the same as a thickness of one of the plurality of second layers.

10. The method of claim 6, wherein the metal layer is approximately twice as thick as one of the plurality of first layers.

11. The method of claim 6, wherein the first material comprises Na₅Al₃F₁₄ and the second material comprises Al₂O₃.

12. The method of claim 1, wherein a last layer of the dielectric multilayer comprises Al₂O₃.

13. A method, comprising:
providing an optical component, a surface of the optical component having parallel, periodically structured surface sections, each surface section having first and second flanks, the first and second flanks of each surface section being inclined with respect to one another, and the first flank of each surface section being smaller than the second flank of the surface section; and
applying a coating to at least part of the first flank of each surface section, the coating including a metal layer and a dielectric multilayer, the metal layer being applied before the dielectric multilayer,
wherein applying the coating comprises coating the part of the first flank at an angle ε that is less than 10° relative to a surface normal of the first flank.

14. The method of claim 13, wherein applying the coating further comprises coating a part of the second flank at an angle η greater than 85° relative to a surface normal of the second flank.

15. The method of claim 13, wherein the angle ε is less than 5°.

16. The method of claim 14, wherein the angle η is greater than 90°.

17. The method of claim 13, further comprising altering a tilt angle δ of the optical component with respect to a horizontal to set the angle ε.

18. The method of claim 13, wherein at most 30% of the first flank is uncoated.

19. A component, comprising:
an optical component configured to select a wavelength for a laser arrangement, the optical component having a surface with parallel, periodically structured surface sections, each surface section having first and second flanks inclined relative to each another, the first flank of each surface section being smaller than the second flank of the surface section, the first flank of each surface section being at least partially coated with a coating that comprises a metal layer and a dielectric multilayer supported by the metal layer, and the second flank being uncoated or having a coating that is less thick than the coating of the first flank.

20. The optical component of claim 19, wherein at most 30% of the first flank is uncoated.

21. The optical component of claim 19, wherein the metal layer comprises aluminum.

22. The optical component of claim 19, wherein the dielectric multilayer has a plurality of first layers comprising a first material and a plurality of second layers comprising a second material, the first and second layers arranged in an alternating sequence.

23. The optical component of claim 22, wherein the dielectric multilayer comprises four of the first layers and four of the second layers.

24. The optical component of claim 22, wherein a thickness of each of the first layers is approximately twice as much as a thickness of each of the second layers.

25. The optical component of claim 22, wherein a first applied layer of the plurality of first layers has a thickness that is approximately the same as a thickness of one of the plurality of second layers.

26. The optical component of claim 22, wherein the metal layer is approximately twice as thick as one of the plurality of first layers.

27. The optical component of claim 22, wherein the first material comprises Na₅Al₃F₁₄ and the second material comprises Al₂O₃.

28. The optical component of claim 19, wherein a last layer of the multilayer comprises Al₂O₃.

29. The optical component of claim 19, wherein the optical component is an Echelle grating.

30. The optical component of claim 19, wherein the first flank is a blaze flank and the second flank is an antiblaze flank.

31. A component, comprising:
an optical component configured to select a wavelength for a laser arrangement, the optical component having a surface with parallel, periodically structured surface sections, each surface section having first and second flanks inclined relative to each other, the first flank of each surface section being smaller than the second flank of the surface section, the first flank of each surface section being at least partly coated with a coating, the coating comprising a metal layer and a dielectric multilayer supported by the metal layer, and a ratio of a thickness of the coating of the second flank to a thickness of the coating of the first flank being in a range from 0 to about ⅓.

32. The optical component of claim 31, wherein the ratio is in a range from 0 to about ⅕.

33. The optical component of claim 31, wherein the ratio is in a range from 0 to 1/10.

34. An arrangement, comprising
a laser arrangement configured to generate a light beam having a defined wavelength, the laser arrangement comprising the optical component of claim 19.
